(19) United States
(12) Patent Application Publication
(10) Pub. No.: US 2016/0140510 A1
(43) Pub. Date: May 19, 2016

(54) METHODS AND APPARATUS FOR USER-CUSTOMIZED ZONE FORMATION IN GEOGRAPHICALLY-BASED EVENT SCHEDULING

(71) Applicant: Gary Allen Schultz, Tigard, OR (US)

(72) Inventor: Gary Allen Schultz, Tigard, OR (US)

(21) Appl. No.: 15/001,219

(22) Filed: Jan. 19, 2016

Related U.S. Application Data
(63) Continuation-in-part of application No. 14/475,184, filed on Sep. 2, 2014, now Pat. No. 9,272,418.
(60) Provisional application No. 62/104,678, filed on Jan. 16, 2015.
(60) Provisional application No. 62/104,678, filed on Jan. 16, 2015.

(51) Int. Cl. G06Q 10/10; G06Q 50/16

(52) U.S. Cl. CPC G06Q 10/1095; G06Q 50/16

(57) ABSTRACT

Methods and apparatus are provided to streamline event scheduling and facilitate commerce and interpersonal exchanges by providing and scheduling related events in user-customized zones in a geographic region. An automated event scheduling system obtains a geographic region, provides a zone request that specifies the geographic region to a remote user device, receives user-provided parameters from the remote user device, and divides the geographic region into zones based on the user-provided parameters. The automated event scheduling system can then provide a set of zone assignments that assigns the zones to the time slots, and transmits the set of zone assignments to the remote user device, which activates a scheduling client running on the remote user device to display, via a user interface, the set of zone assignments and enable a modification of the set of zone assignments.

### CLAIM OF PRIORITY

The present application for patent is a continuation-in-part of and claims priority to U.S. patent application Ser. No. 13/097,486 that was filed Apr. 29, 2011 by Gary Allen Schultz and is pending, which is hereby expressly incorporated by reference in its entirety. U.S. patent application Ser. No. 13/097,486 relates to U.S. Provisional Application No. 61/329,705 filed Apr. 30, 2010, entitled “Methods and Apparatus for Geographically-Based Event Scheduling,” by Gary Allen Schultz, from which provisional application priority is claimed, and which provisional application is incorporated by reference herein. The present application also claims priority to provisional U.S. Patent Application Ser. No. 62/104,678 filed Jan. 16, 2015 by Gary Allen Schultz, which is hereby expressly incorporated by reference in its entirety.

### FIELD

The present teachings relate generally to methods and apparatus for customizing formation of zones as partitions of a geographic region and scheduling similar events with venues in the zones for time slots assigned to the zones.

### BACKGROUND

There have been three waves of technological evolution in the real estate industry. The first wave was the classic bricks-and-mortar model in which information was controlled by brokers. The second wave arose in the 1970s and coincided with the introduction of scalable computing that culminated with the personal computer. This led to franchised models and national distribution with agents and professional brokers as the primary focal point, which created artificial barriers and increased transaction costs for consumers in numerous industries.

The third wave began in the 1990s with the advent of the Internet. With this wave, traditional barriers began to crumble and provided individuals greater access to information and control of the process. For example, for-sale-by-owner (“FSBO”) companies provide a lower-cost option to traditional real estate brokerages. For a lower commission or a fixed-fee, people can list their properties online with a FSBO company. However, FSBO companies fail to address leading challenges in real estate transactions. There is no method for easily bringing together buyers and sellers, renters and landlords, lessees and lessors, etc., and there is no real integration with partners to make it easier for everyday people to manage real estate transactions.

Existing Internet-based solutions, like FSBO companies, have been limited in scope due to immaturity of tools and resistance from entrenched real estate players. The real estate industry has been very resistant to change, and because resolving the major issues in real estate transactions requires a major paradigm shift, current FSBO companies in the market have chosen to dovetail with the existing business model in order to find a niche and survive. Consequently, the current operation of real estate transactions remains arcane and expensive and the marketplace is cluttered with fragmented solutions that mostly look and behave alike. The existing solutions fail to provide fundamental capabilities that would solve key challenges in the real estate market, such as a convenient way to bring together buyers and sellers, renters and landlords, lessors and lessees, etc., and a simple way to manage the complexity of a real estate transaction.

### SUMMARY

According to the present teachings in one or more aspects, methods and apparatus are provided to streamline event scheduling and facilitate commerce and interpersonal exchanges in a geographic region, for example, by customizing formation of zones as partitions of the geographic region, assigning time slots to the zones, and scheduling similar events with venues (e.g., where the events are to take place) in the zones based on the zones' assigned time slots. Interpersonal exchanges can include, for example, exchanges of tangible goods, intangible goods, service, knowledge, performance, support, and the like, between two or more participants. Exemplary embodiments of the present teachings include an automated event scheduling system that schedules similar events in a geographic region based on geographic locations of the events' venues. The automated event scheduling system can obtain parameters provided by users and, based on the user-provided parameters, provide and partition the geographic region into discrete, user-customized zones. Users can be individuals or agents of organizations authorized to create, modify, remove, and/or manage one or more geographic regions or zones within the geographic regions, examples of which include the automated event scheduling system's administrators, authorized event organizers or managers, authorized event brokers or brokerages, and the like.

Subsequent to zone formation, the automated event scheduling system can assign one or more time slots to each of the zones, and the events with venues located in each zone are scheduled for the time slots assigned to that zone. In doing so, exemplary embodiments of the present teachings provide an innovative way of conveniently connecting participants in various types of events, such as buyers and sellers, renters and landlords, lessees and lessors, consumers and providers of goods or services, audiences and performers, etc., based on a geographic proximity of the events' venues, thus providing and empowering everyday people and individuals with the capability to easily congregate to participate in various types of related events and/or conduct various types of related exchanges or transactions.

In various embodiments, a zoning module of the present teachings can provide a geographic region containing discrete geographic elements and partition the geographic region into discrete zones. The zoning module can obtain user-provided information and customize the discrete zones and/or the geographic region based on user-provided information. The zoning module can provide the user-customized geographic region, for example, by receiving and validating one or more user-provided parameters for the geographic region and generating a closed shape (e.g., a polygon, a circle or an ellipse, etc.) that bounds the geographic region based on the user-provided parameters. The zoning module can divide the closed shape into multiple user-customized zones, for example, by receiving one or more user-provided parameters for the zones and partitioning the closed shape into the zones based on the user-provided parameters. The zoning module can include a selector tool that interfaces with a map database and a user interface (“UI”) module that can access the map database to provide at least one UI containing one or more maps, receive user input via the UI, and translate the user input into the user-provided parameters. The zoning module can also divide the closed shape into multiple zones based on other parameters, such as a density and/or distribution of geographic elements within the closed shape.

In further embodiments, a scheduling engine of the present teachings assigns time slots to discrete zones within a geographic region. The time slots can be temporally discrete, and each time slot can have a defined duration. According to the present teachings in one or more aspects, the scheduling engine can determine a time frame and divide the time frame into a number of discrete time slots based on, for example, a number of zones partitioned from the geographic region, a desired periodicity for events scheduled to transpire in the geographic region, and/or a desired time duration for each of the scheduled events. Events can include, for example, open houses, auctions, gatherings, performances, tournaments, and other types of interpersonal exchanges of tangible goods, intangible goods, currency, service, knowledge, performance, support, and the like. The scheduling engine can assign one or more time slots to each of the zones within the geographic region based on a scheduling scheme. In some embodiments, the scheduling engine can assign each time slot to at most one zone. In other embodiments, the scheduling engine can assign each time slot to any number of zones. For each of the zones, the scheduling engine can schedule events associated with geographic elements in the zone to transpire during the time slots assigned to the zone. For instance, for events with venues located in any one of geographic elements within a particular zone, the scheduling engine can schedule those events to transpire during the time slots assigned to that particular zone.

### DESCRIPTION OF THE DRAWINGS

The accompanying drawings, which are incorporated in and constitute a part of this specification, illustrate aspects of the present teachings and together with the description, serve to explain principles of the present teachings. In the figures:

FIGS. 1A-C illustrate exemplary embodiments of an automated event scheduling system that partitions a geographic region into discrete, user-customized zones, assigns predefined time slots to each of the zones, and schedules events with venues located in each zone to transpire during time slots assigned to that zone, consistent with various embodiments of the present teachings;

FIGS. 2-4 illustrate flowcharts of processing performed by the automated event scheduling system, in accordance with various embodiments of the present teachings;

FIGS. 5-7 show screenshots of exemplary discrete zones partitioned from a geographic zone and assigned to time slots, according to an embodiment of the present teachings;

FIGS. 8A and 8B illustrate flowcharts of processing performed by the automated event scheduling system, in accordance with various embodiments of the present teachings;

FIGS. 9A-D show screenshots of exemplary graphical user interfaces displaying events being scheduled to transpire in discrete zones of a geographic region during time slots assigned to the zones, according to an embodiment of the present teachings; and

FIG. 10 illustrates a computer system that is consistent with embodiments of the present teachings.

### DETAILED DESCRIPTION

Reference will now be made in detail to exemplary embodiments of the present teachings, an example of which is illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific embodiments in which may be practiced. These embodiments are described in sufficient detail to enable those skilled in the art to practice these embodiments and it is to be understood that other embodiments may be utilized and that changes may be made without departing from the scope of the present teachings. The following description is, therefore, merely exemplary.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

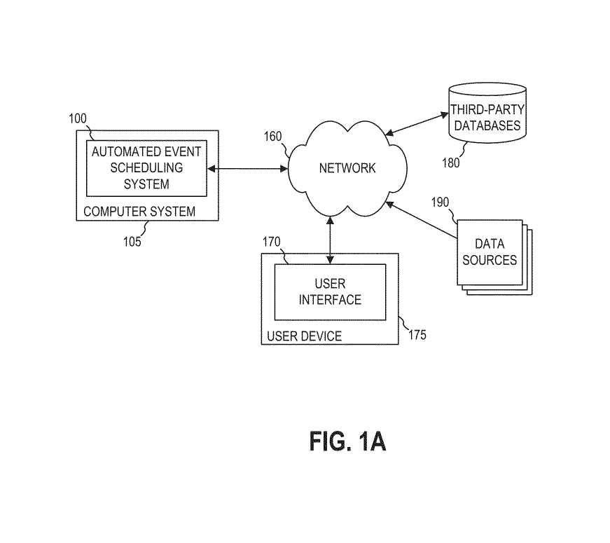

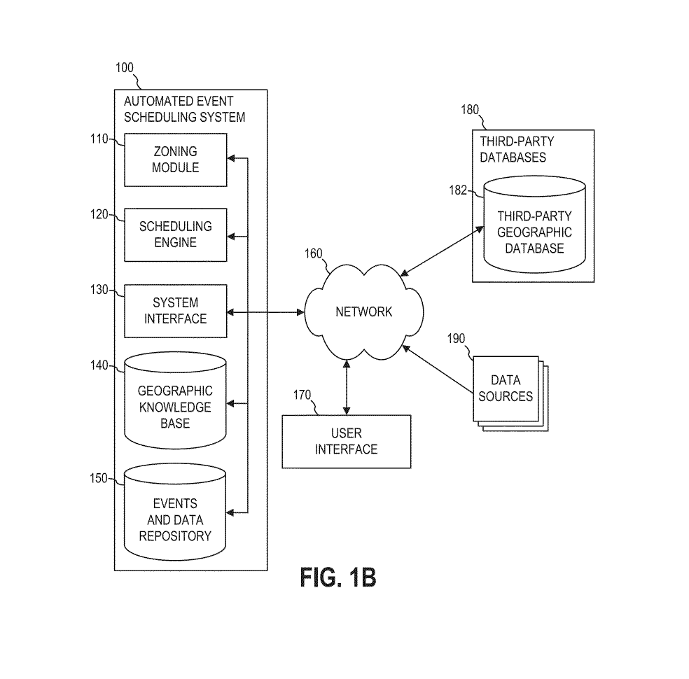

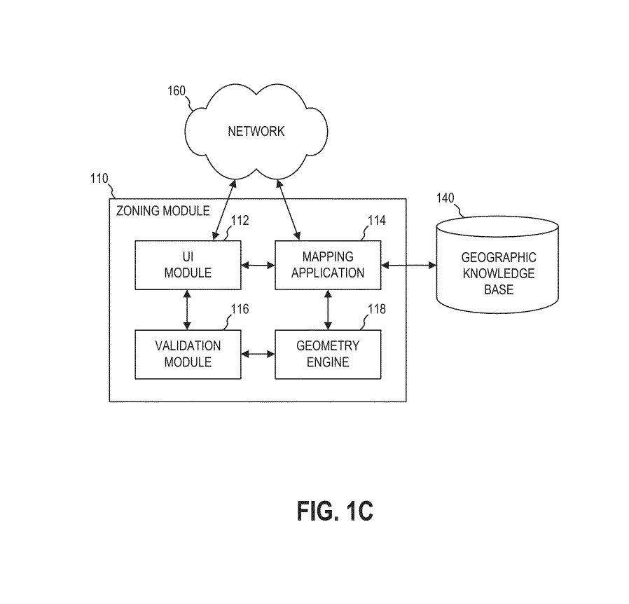

FIGS. 1A-C illustrate exemplary systems that streamline event scheduling and facilitate commerce and interpersonal exchanges, in which an exemplary automated event scheduling system 100 schedules events for predefined time slots based on geographic locations of the events' venues, and in doing so, provides network effect to the benefit of participants by connecting interested parties and enhancing economies of scale. Interpersonal exchanges can include, for example, exchanges of tangible goods, intangible goods, service, knowledge, performance, support, and the like, between two or more participants. More particularly, in various aspects, and as generally shown in the figures, platforms and techniques are provided to obtain user-provided parameters with which a geographic region is provided and partitioned into discrete zones, assign predefined time slots to each of the zones, and schedule events with venues located in each zone for the time slots assigned to that zone. Exemplary embodiments of automated event scheduling system 100 can schedule related events in a geographic region for predefined time slots based on geographic locations of the events' venues, e.g., where the events are to take place in the geographic region.

Automated event scheduling system 100 can obtain user-provided parameters, provide and partition a geographic region into discrete zones based on the user-provided parameters, assign to each zone one or more time slots, and schedule the events with venues located in each zone for the time slots assigned to that zone. In doing so, exemplary embodiments of the present teachings provide an innovative way of conveniently connecting participants in various types of events, such as buyers and sellers, renters and landlords, lessees and lessors, consumers and providers of goods or services, audiences and performers, etc., based on a geographic proximity of the events' venues, thus providing and empowering everyday people and individuals with the capability to easily congregate to participate in various types of related events and/or conduct various types of related exchanges or transactions.

According to various embodiments, automated event scheduling system 100 can obtain parameters from users and, based on the user-provided parameters, provide and partition a geographic region into discrete zones. Users can be individuals or agents of organizations authorized to create, modify, remove, and/or manage one or more geographic regions or zones within the geographic regions. Examples of users include administrators of automated event scheduling system 100, authorized event organizers or managers, authorized event brokers or brokerages, and the like. In doing so, automated event scheduling system 100 provides end-users (e.g., event participants, etc.) with the convenience and efficiency of participating in events that are to take place in proximity with each other within a given time slot.

Exemplary embodiments of automated event scheduling system 100 can streamline event scheduling and facilitate commerce and interpersonal exchanges by scheduling events in predefined time slots based on geographic locations of the events' venues. In doing so, automated event scheduling system 100 provides individuals with the benefit of network effect and enables them to be in control of transactions and exchanges in industries such as, for example, the real estate industry (residential, commercial, rental, etc.), the auction industry (e.g., car auctions, furniture auctions, livestock auctions, etc.), professional, religious, community, and/or social event planning and coordination (e.g., sporting events, professional networking events, religious gatherings, sports leagues, substance abuse rehabilitation meetings, wine-tasting events, etc.), and the like. Individuals, such as buyers, sellers, renters, landlords, lessees, lessors, audiences, performers, consumers, goods and/or service providers, and the like, are now empowered to schedule, conduct, and manage geographically-based events and transactions.

According to various embodiments, automated event scheduling system 100 can obtain user-provided parameters from the users and provide and partition a geographic region into discrete zones based on the user-provided parameters. In doing so, automated event scheduling system 100 provides the end-users with the convenience and efficiency of participating in events that are to take place in proximity with each other within a given time slot. This maximizes the number of events that the end-users can participate in and enhances the network effect provided to the end-users, while decreasing the associated costs and travel time. The zones, when combined, can cover the entire geographic region or only a portion of the geographic region. In some embodiments, automated event scheduling system 100 can partition the geographic region such that each of the zones contains a substantially equal subset of the geographic elements. In other embodiments, automated event scheduling system 100 can partition the geographic region such that the zones contain unequal subsets of the geographic elements.

In various embodiments, automated event scheduling system 100 can generate the geographic region, which can be a closed shape (e.g., a polygon, an ellipse, etc.) that encloses a geographic area, and divide the geographic region into multiple zones. As shown in FIG. 1B, automated event scheduling system 100 can include a zoning module 110 that obtains user-provided parameters associated with the geographic region, selects a geographic area based on the user-provided parameters, and generates, based on the user-provided parameters, the geographic region in the form of a closed shape that encloses the geographic area or a portion thereof. In addition or alternatively, zoning module 110 can determine an overall size and a general shape of a geographic area and dynamically generate the geographic region in the form of a closed shape that encloses the geographic area or a portion thereof.

Subsequent to generating the geographic region, zoning module 110 can divide the geographic region into multiple zones by receiving user-provided information for forming zones and using the user-provided information to divide the geographic region into zones. For example, zoning module 110 can provide a map of the geographic region and receive user-provided information for dividing the geographic region into zones. The user-provided information can include one or more user-provided points on the map, user-selected features or boundaries on the map, and/or user-provided parameters. Each zone can be a polygon with any number of sides, an ellipse, or any closed shape bound by lines and/or curves. In addition or alternatively, zoning module 110 can divide the geographic region into multiple zones based on other characteristics, such as a density and/or distribution of geographic elements within the closed shape.

Zoning module 110 can provide at least one UI 170 for the users to view at least one map of the geographic region and select points and/or areas within the map to obtain user-provided parameters, and can generate user-customized zones in the geographic region based on the user-provided parameters. For example, zoning module 110 can divide the geographic region into one or more zones in the form of closed shapes in the geographic region based on user-provided points (e.g., one or more coordinates for at least one vertex and/or edge of a polygon, one or more coordinates for at least one focus of an ellipse, and the like), one or more natural or manmade boundaries or features (e.g., a shoreline, a borderline, a mountain range, an elevation contour, a road, a political boundary, and the like), attributes (e.g., a total area for a polygon, a total area or at least one radius for an ellipse, and the like), and/or other information (e.g., population density, demographics, and the like).

As shown in FIG. 1C, zoning module 110 can include a user interface (“UI”) module 112, a mapping application 114, a validation module 116, and a geometry engine 118. UI module 112 can access one or more map databases (e.g., a geographic knowledge base 140, third-party databases 180, data sources 190, etc.) via mapping application 114. Mapping application 114 can provide maps and other mapping related services, such as translation services that convert (x,y) coordinates selected on a map displayed two-dimensionally to a coordinate space such as geographical (lat/long), polar, spherical, etc.

UI module 112 can interact with at least one of the users by providing at least one map of the geographic region and interacting with the user to collect the user-provided parameters, such as one or more points, boundaries, features, attributes, and other information associated with a geographic area. The user-provided points can be any type of information as long as the points can be directly or indirectly linked to a coordinate space. UI module 112 can work with mapping application 114 to determine coordinate sets (latitude, longitude, and/or altitude) for the user-provided parameters on the map, and can store these coordinate sets in a data structure, with each coordinate set including a tuple having a first value and a second value in a coordinate space.

UI module 112 can instantiate an object data structure to store the coordinate sets for forming the zones and transmit the object data structure to validation module 116. Validation module 116 can validate the coordinate sets for forming the zones, for example, by validating that the coordinate sets would partition the geographic region into discrete zones, i.e., non-overlapping zones. Subsequent to a successful validation, validation module 116 can forward the coordinate sets to geometry engine 118. Geometry engine 118 can then generate the zones based on the coordinate sets. Geometry engine 118 can also generalize any zone to an ellipse or a simple polygon, e.g., a rectangle, square, or triangle. For example, geometry engine 118 can determine the maximum and minimum first value of the received coordinate sets and the maximum and minimum second value of the received coordinate sets for the closed shape to form a four-side polygon if the number of sides of the closed shape exceeds five.

In various embodiments, automated event scheduling system 100 can provide time slots and assign zones partitioned from a geographic region to the time slots. Automated event scheduling system 100 can determine a time frame and divide the time frame into discrete time slots based on, for example, a number of zones in the geographic region, a desired periodicity for events scheduled to take place in the geographic region, and/or a desired duration for each of the scheduled events, and then assign one or more time slots to each of the zones within the geographic region based on a scheduling scheme. In some embodiments, automated event scheduling system 100 can assign at most one zone to each time slot. In other embodiments, automated event scheduling system 100 can assign any number of zones to each time slot. For each of the zones, automated event scheduling system 100 can schedule events associated with geographic elements in the zone to transpire during the time slots assigned to the zone. For instance, events with venues located in or at any one of geographic elements within a particular zone can be scheduled to transpire during the time slots assigned to that particular zone. After assigning time slots to the zones, automated event scheduling system 100 can reserve, for the events, time slots that are assigned the zones in which the events are to take place, based on, for example, user input via UI 170.

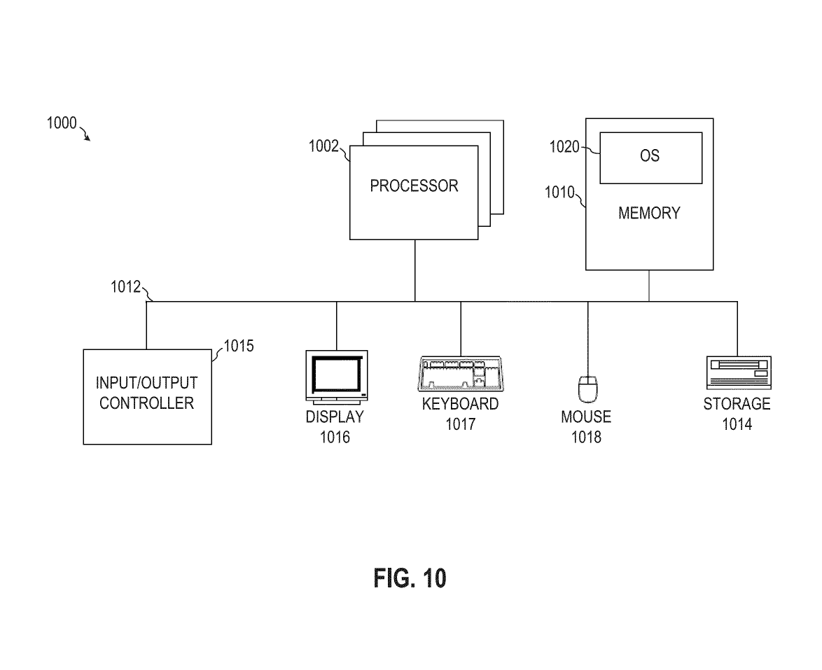

According to various embodiments of the present teachings, automated event scheduling system 100 can be implemented on any type of computer system, such as server computers, desktop computers, virtual machines, laptops, mobile devices, tablet computers, smartphones, personal digital assistants, and the like. The computer system can include components of a conventional computer system, such as components as shown in FIG. 10 and described in greater detail below. In various embodiments, the computer system implementing automated event scheduling system 100 can be configured to operate in conjunction with other computer systems. As illustrated in FIG. 1A, for example, automated event scheduling system 100 can be implemented on a computer system 105 that is communicatively coupled to a network 160. Network 160 can include one or more communication networks, such as a local area network, a wide area network, a cellular network, the Internet, a cloud-based network, and the like, or any combination thereof. In this example, automated event scheduling system 100 can communicate and/or interact with a user via network 160. For instance, automated event scheduling system 100 can communicate with the user via a network-based interface, such as UI 170, which can include a web page, a web portal, an electronic mail application, a messaging application, a media player, and other types of network-based interfaces known to one skilled in the art. As such, the user can utilize automated event scheduling system 100, via UI 170, from a remote user device 175 communicatively coupled to network 160. User device 175 can be any type of client computer system, such as desktop computers, thin clients, virtual machines, laptops, mobile devices, tablet computers, smartphones, personal digital assistants, and the like.

Additionally, automated event scheduling system 100 can communicate with third-party databases 180 and data sources 190 via network 160. For instance, third-party databases 180 and data sources 190 can be supported by one or more remote computer systems communicatively coupled to network 160. Third-party databases 180 can include databases, data files, data records, and the like, and can contain content or data usable by automated event scheduling system 100 to streamline event scheduling and facilitate commerce and interpersonal exchanges. Examples of third-party databases 180 can include, for example, geographic information systems and providers (e.g., GOOGLE MAPS, GOOGLE EARTH, BING MAPS, MAPQUEST, NAVTEQ, etc.), demographic databases (e.g., national, state/provincial, and/or county databases, resident/consumer profile databases, etc.), registries (e.g., deed registries, motor vehicle registries, etc.), and the like. Data sources 190 can include data feeds, web sites, web portals, networks, file uploads, and the like.

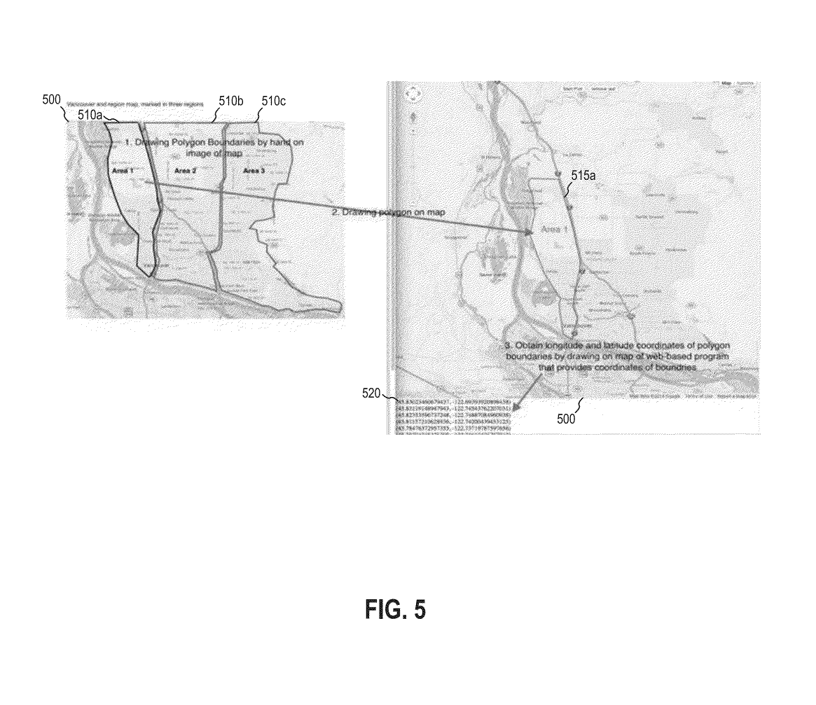

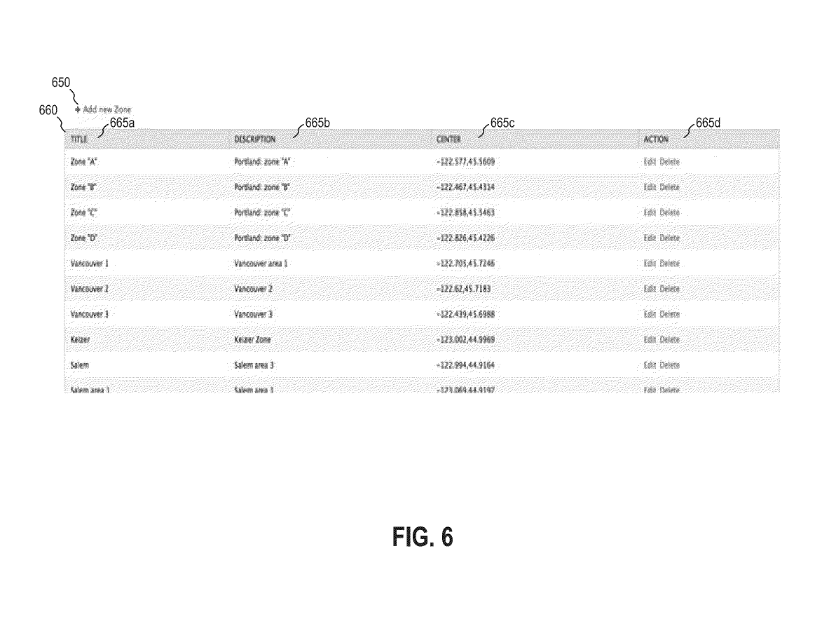

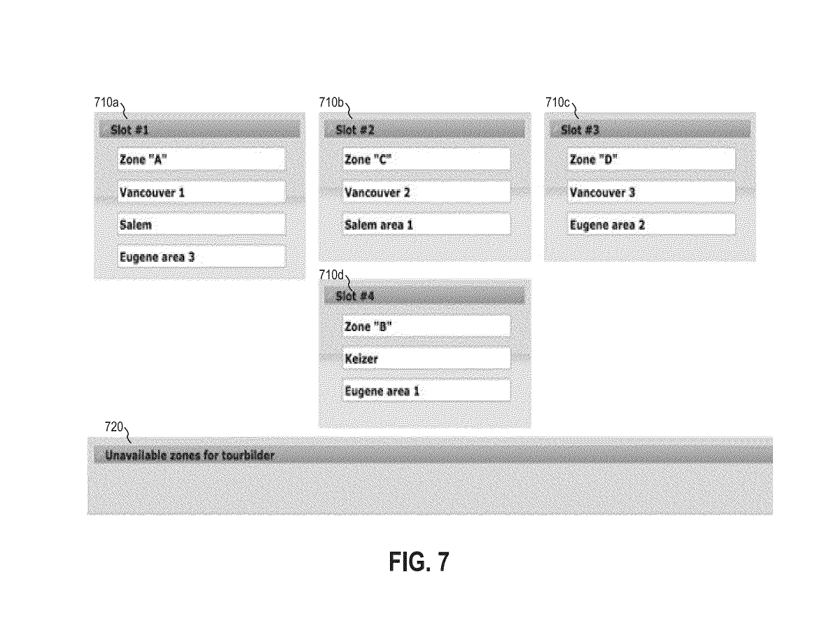

In the example illustrated in FIG. 1A, automated event scheduling system 100 can be implemented on computer system 105, and can interact with a user of remote user device 175 over network 160 via UI 170. Likewise, for example, automated event scheduling system 100 can be locally stored and executed on a computer system of the user, such as user device 175. As such, automated event scheduling system 100 can provide UI 170 as a graphical user interface (“GUI”) to allow the user to utilize automated event scheduling system 100. Exemplary screenshots of UI 170 are shown in FIGS. 5-8 and 9A- and described in greater detail below. Similarly, while third-party databases 180 and data sources 190 are illustrated as being remotely located from automated event scheduling system 100, third-party databases 180 and/or data sources 190 can be implemented locally on computer system 105 and/or user device 175. One skilled in the art will realize that automated event scheduling system 100, third-party databases 180, and data sources 190 can be implemented on any type of computer system or systems configured in any type of arrangement.

According to various embodiments of the present teachings, automated event scheduling system 100 can include modules and/or components that are communicatively coupled to one another. As illustrated in FIG. 1B, for example, modules and/or components of automated event scheduling system 100 can include a zoning module 110, a scheduling engine 120, a system interface 130, a geographic knowledge base 140, and an events and data repository 150.

In various embodiments, zoning module 110 in automated event scheduling system 100 is configured to partition a geographic region that contains discrete geographic elements into discrete zones. All of the zones of a geographic region, when combined, can cover the entire geographic region or only a portion of the geographic region. In some embodiments, zoning module 110 can partition the geographic region such that each of the zones contains a substantially equal subset of the geographic elements. In other embodiments, zoning module 110 can partition the geographic region such that the zones contain unequal subsets of the geographic elements. In various embodiments, zoning module 110 can partition the geographic region based on user input such as one or more user-entered coordinates, one or more user-provided parameters, and the like. Zoning module 110 can also communicate with geographic knowledge base 140 and/or third-party databases 180, such as a third-party geographic database 182, to generate, retrieve, define, and/or store a geographic region. A geographic region can be defined based on, for example, a state or province, a county or subdivision thereof, a municipality (e.g., a town, a city, and the like), a ZIP code, a district or precinct (e.g., a school district, a voting district, and the like), a university or corporate campus or other institutional properties, a street-delimited geographic area, a polygonal geographic area, a circular geographic area, a semi-circular geographic area (e.g., a cellular sector), a geographic area serviced by a telephone area code, a wireless communication service area serviced by a wireless communication system, and the like, or a combination thereof. A geographic region can include discrete geographic elements. Thus, a geographic element can be defined as a discrete partition of a geographic region that is separate and distinct from other geographic elements in the geographic region. Examples of a geographic element can include a county or a subdivision thereof, a municipality, a district or precinct, a subdivision, a neighborhood, and the like, or any combination thereof. For instance, if a geographic region includes a state, then a geographic element can include a county or a subdivision thereof, a municipality, a telephone area code, etc., in that state. For another instance, if a geographic region includes a city, then a geographic element can include a sector (e.g., north, south, east, west, first, second, etc., or any combination thereof), a district or precinct, a ZIP code, a subdivision, a neighborhood, etc., in the city.

Zoning module 110 can form a shape, e.g., a polygon, a circle, or another closed shape, that bounds the geographic region. Zoning module 110 can divide the shape, either vertically or horizontally, into multiple parcels based on, for example, a density and/or distribution of geographic elements within the shape. Zoning module 110 can also divide the shape into multiple parcels based on user input, such as user-entered coordinates, user-provided parameters, and the like. A parcel is defined as a geographic unit that includes a subdivision of a geographic region that can be further divided into zones, and a parcel can contain geographic elements. In some embodiments, zoning module 110 can divide the shape such that each of the parcels has a substantially equal number of the geographic elements. In other embodiments, zoning module 110 can divide the shape such that the parcels have an unequal number of the geographic elements. Zoning module 110 can then divide the parcels into a predetermined number of zones based on, for example, a density and/or distribution of the geographic elements within each of the parcels. Zoning module 110 can divide the parcels either horizontally or vertically into zones based on how the shape was initially divided into parcels. In various embodiments, zoning module 110 can divide the shape directly into zones based on user input such as one or more user-entered coordinates, one or more user-provided parameters, and the like. A zone is defined as a geographic unit that includes a discrete subdivision of a geographic region, and a zone can contain one or more geographic elements. A zone in a geographic region is defined as being discrete from all other zones in the geographic region, and can be further defined as being non-overlapping with the other zones. Zones of a geographic region, when combined, can cover the geographic region in its entirety or only a portion of the geographic region.

In further embodiments, automated event scheduling system 100 can include a scheduling engine 120 configured to assign time slots to zones partitioned from a geographic region. Scheduling engine 120 can determine a time frame for events to transpire in the geographic region, and divide the time frame into a number of discrete time slots based on a number of zones partitioned from the geographic region, a desired periodicity for the events, a desired time duration for each event, and the like. Each time slot in a time frame can be temporally discrete from all other time slots in the time frame, and each time slot can have a defined duration. Furthermore, time slots in a time frame can have the same duration or different durations.

In various embodiments, the number of time slots can be a multiple of the number of zones in the geographic region. For example, for a geographic region that comprises six zones, scheduling engine 120 can generate thirty-six time slots for events that are to take place in the geographic region over a time frame of six weeks. Scheduling engine 120 can then assign one or more time slots to each of the zones within the geographic region based on a scheduling scheme. In some embodiments, scheduling engine 120 can assign each time slot to at most one zone. In other embodiments, scheduling engine 120 can assign each time slot to any number of zones. Using the above example, scheduling engine 120 can assign six unique time slots to each of the six zones, or one unique time slot per zone for each week during the six week time frame. Moreover, scheduling engine 120 can assign concurrent sets of time slots to the geographic region. For example, scheduling engine 120 can assign a first set of time slots for the weekends during a time frame and a second set of time slots for the weekdays during the same time frame or an overlapping time frame. For another example, scheduling engine 120 can assign a first set of time slots for Mondays, Wednesdays, and Fridays during a time frame, and assign a second set of time slots for Tuesdays, Thursdays, and Saturdays during the same time frame or an overlapping time frame. For each of the zones, scheduling engine 120 can schedule events associated with geographic elements in the zone to transpire during the time slots assigned to the zone. For events that have venues located in any one of geographic elements within a particular zone, scheduling engine 120 can schedule any number of those events to transpire during one or more of the time slots assigned to that particular zone. Furthermore, scheduling engine 120 can reserve assigned time slots for events, based on, for example, user input via UI 170.

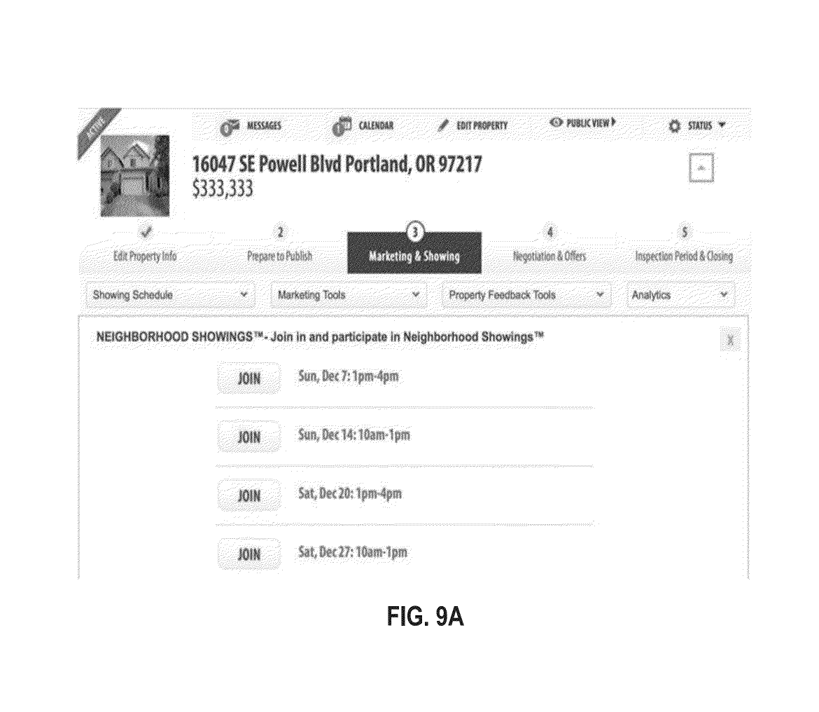

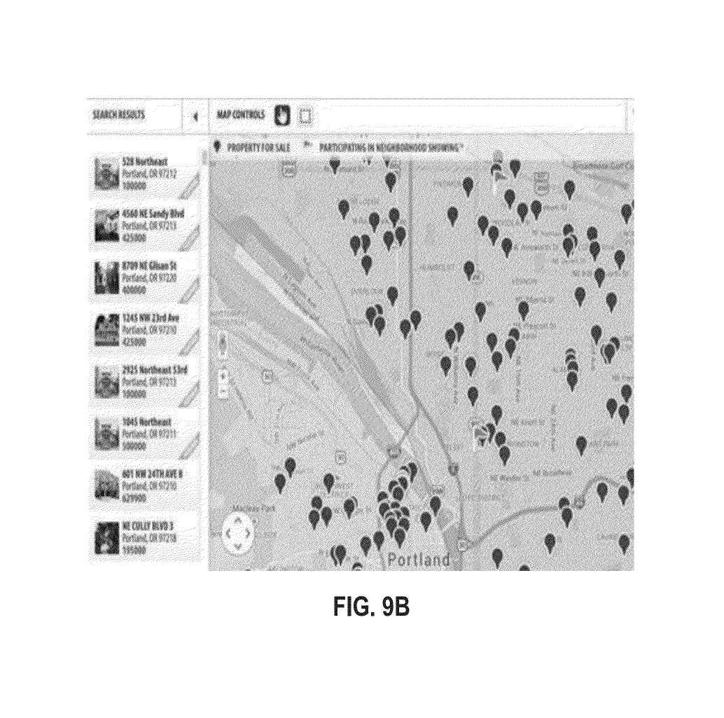

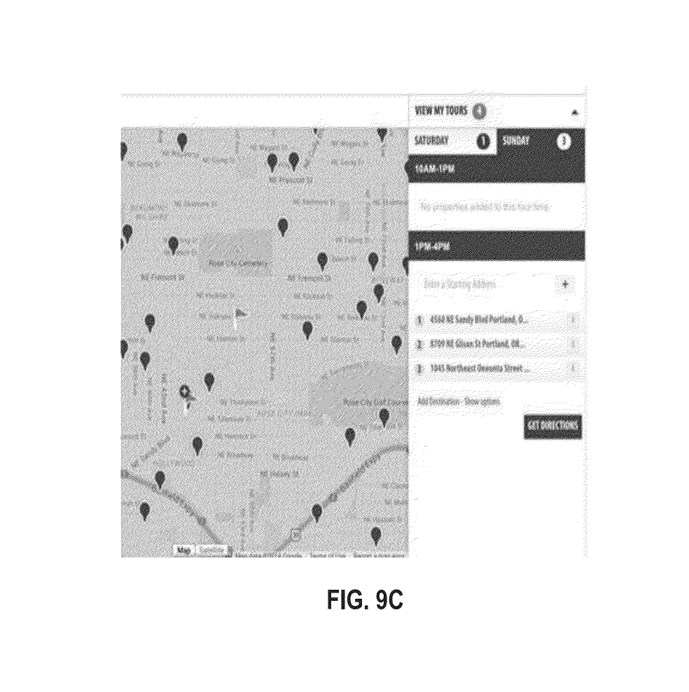

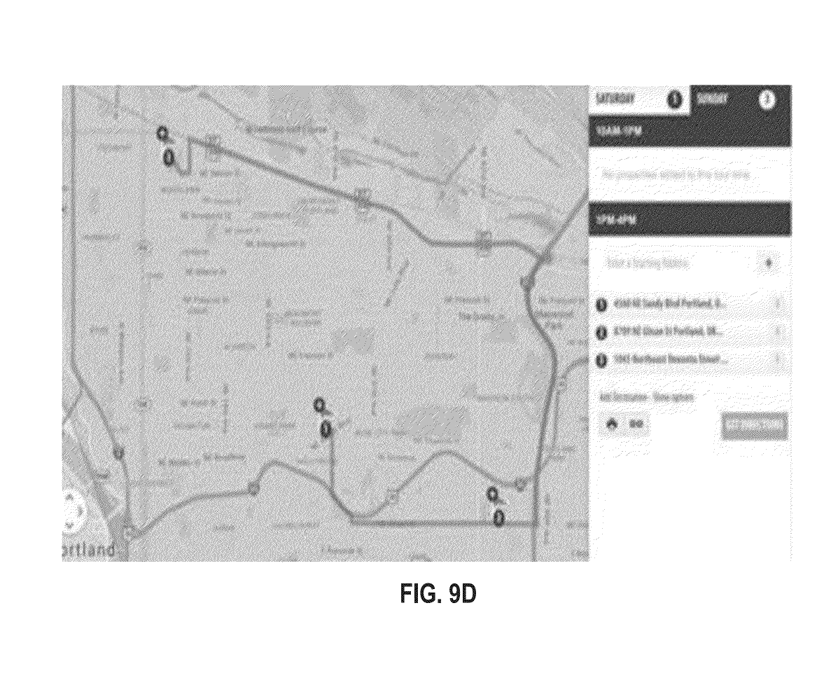

Automated event scheduling system 100 can also include system interface 130 configured to serve as an interface for modules and components in automated event scheduling system 100 to external systems and components. For instance, system interface 130 can provide display data to UI 170, receive user input from UI 170, communicate with third-party databases 180 and/or data sources 190, and the like. For example, system interface 130 can provide display data for UI 170 to render a graphical representation of a geographic region, one or more zones partitioned from the geographic zone, a set of geographic elements in all or a portion of the geographic region, a set of events scheduled to transpire in all or a portion of the geographic region, a set of venues located in the geographic region and at which events are scheduled or can be scheduled to take place, and the like, or any combination thereof. Also for example, system interface 130 can receive user input from UI 170 to access or create/modify a geographic region, access or create/modify a time frame and/or time slots therein, access or create/modify one or more zones, access or create/modify one or more events scheduled to take place in the geographic region, access or create/modify one or more geographic element or venues located in the geographic region, and the like, or any combination thereof. FIGS. 9A and 9B show exemplary screenshots generated by UI 170 based on display data provided by system interface 130, which depict events scheduled or being scheduled to transpire in a discrete zone of a geographic region during time slots assigned to that zone.

In various embodiments and as shown in FIG. 1B, automated event scheduling system 100 can include geographic knowledge base 140 that provides for the collection, organization, and retrieval of geographic knowledge that can include, for example, geographic and/or geospatial data, data models, metadata, regions, elements, entities, features, concepts, associations, hierarchy, and other geographic information describing the natural and human environment. Geographic knowledge base 140, in conjunction with zoning module 110, enables automated event scheduling system 100 to generate, retrieve, define, and/or store a geographic region that contains discrete geographic elements and partition the geographic region into discrete zones. According to various embodiments, zoning module 110 can store, organize, and retrieve data associated with the geographic region as well as zones and geographic elements contained therein in system storage provided by automated event scheduling system 100, such as geographic knowledge base 140 and/or events and data repository 150 as shown in FIG. 1B. Zoning module 110 can receive, organize, and retrieve data from the system storage as well as various other data sources, such as users via UI 170, third-party databases 180, and/or data sources 190.

In further embodiments, automated event scheduling system 100 can include events and data repository 150 that provides for the collection, organization, and retrieval of data related to events, venues for the events, time frames and slots during which events take or can take place, and other event-related data. Events and data repository 150, in conjunction with zoning module 110 and scheduling engine 120, enables automated event scheduling system 100 to generate, retrieve, define, and/or store time frame(s) and time slots assigned to zones partitioned from a geographic region as well as events that have venues located within those zones. According to various embodiments, scheduling engine 120 can store, organize, and retrieve data associated with time frame(s) and slots assigned to zones in a geographic region as well as events and venues contained in those zones in the system storage provided by automated event scheduling system 100, as shown for example in FIG. 1B.

In various embodiments, automated event scheduling system 100 can be implemented as an application program that is capable of being stored on and executed by any type of computer system, for example, as illustrated in FIG. 10. Automated event scheduling system 100 an be written in a variety of programming languages, such as JAVA, C++, Python code, Visual Basic, HTML, XML, and the like, to accommodate a variety of operating systems, computing system architectures, etc. The modules and/or components of automated event scheduling system 100 can be implemented in a single application program or separate application programs capable of executing on one computer system as illustrated, for example, in FIGS. 1A-C. Likewise, the modules and/or components of automated event scheduling system 100 can be implemented as separate application programs that are capable of executing on separate computer systems. For example, the modules and/or components in automated event scheduling system 100, such as zoning module 110, scheduling engine 120, system interface 130, geographic knowledge base 140, and/or events and data repository 150, can be separate and can communicate via one or more communication networks, such as a local area network, a wide area network, a cellular network, the Internet, a cloud-based network, and the like, or any combination thereof. While FIG. 1B illustrates all the modules and/or components in automated event scheduling system 100 as being separate, any number of the modules and/or components in automated event scheduling system 100 can be located in separate application programs and/or in the same application program.

The embodiments of automated event scheduling system 100, such as those described herein and illustrated in FIGS. 1A-C, are intended to present concepts in a concrete fashion and are described in sufficient detail to enable those skilled in the art to practice these embodiments. However, other embodiments can be utilized and changes can be made without departing from the scope of the present teachings.

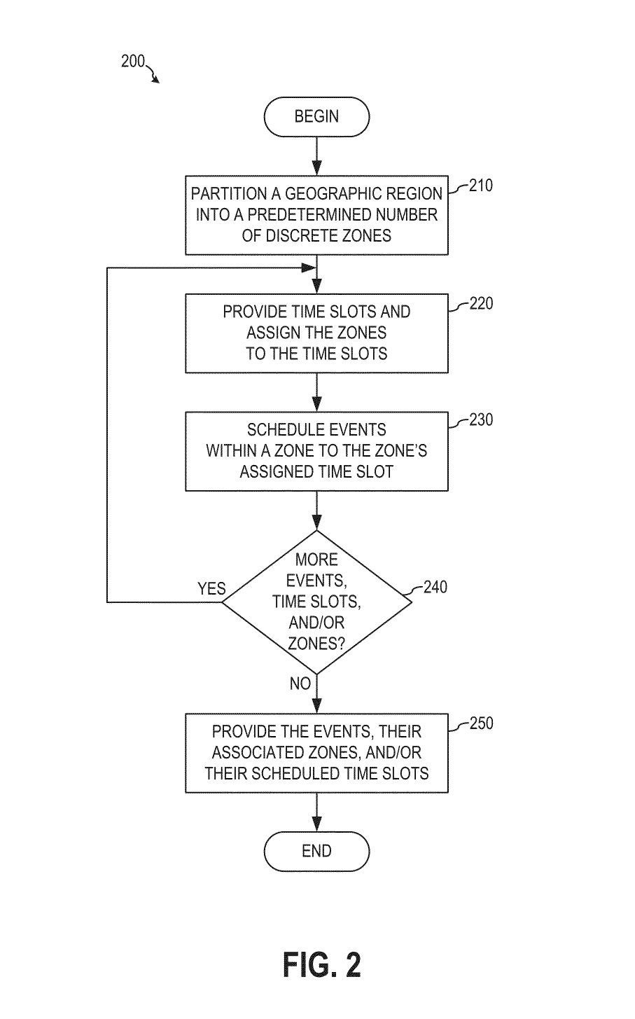

FIGS. 2-4 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIGS. 2-4 illustrate flowcharts of processing 200, processing 300, and processing 400 that can be performed by automated event scheduling system 100 (as shown in FIGS. 1A-C) to obtain parameters from one or more users, provide and partition a geographic region into discrete, user-customized zones based on the user-provided parameters, assign predefined time slots to each of the zones, and schedule events with venues located in each zone for the time slots assigned to that zone. Processing 200 begins in 210, during which automated event scheduling system 100 can obtain one or more user-provided parameters, generate/define a new geographic region or select/retrieve a stored geographic region, and partition the geographic region into discrete, user-customized zones. All of the user-customized zones partitioned from the geographic region, when combined, can cover the entire geographic region or only a portion of the geographic region.

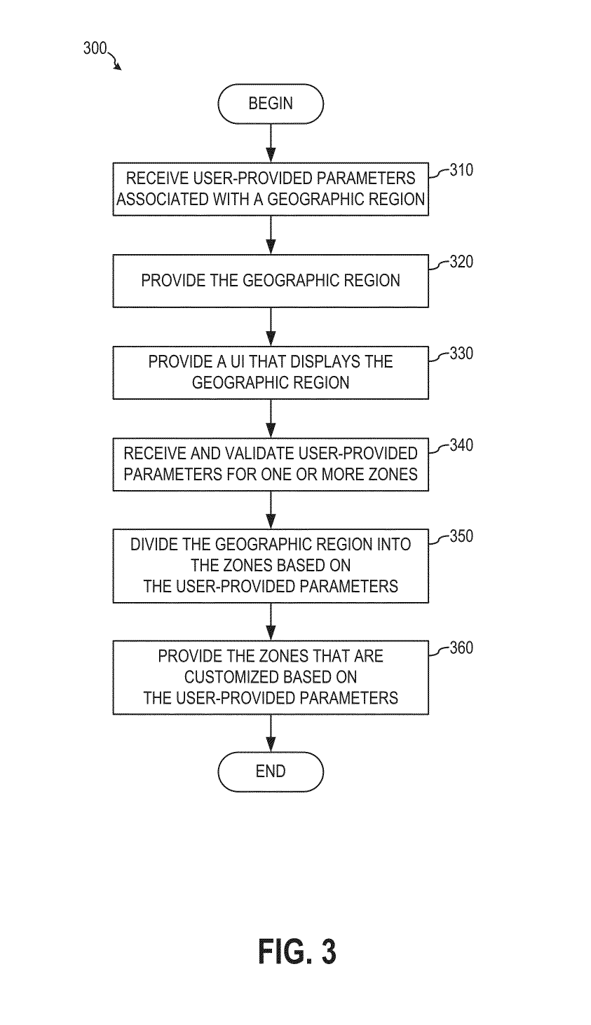

More particularly, automated event scheduling system can invoke zoning module 110 to perform processing 300 as shown in FIG. 3. In 310, zoning module 110 can receive a user request to create or retrieve a geographic region. The user request includes one or more user-provided parameters associated with the geographic region, such as one or more identifiers or attributes that identify or define the geographic region. Identifiers can identify an existing geographic region, one or more natural or manmade boundaries or features (e.g., a shoreline, a political boundary, a mountain range, an elevation contour, a road, and the like). Attributes can define a geographic area based on a set of coordinates, a total area, a center and a radius, population or population density, demographics, and the like. Zoning module 100 can translate the user-provided parameters for the geographic region into a set of coordinates that defines a closed shape enclosing the geographic region.

Next, in 320, zoning module 110 can provide the geographic region based on the user-provided parameters associated with the geographic region, for example, by creating a new geographic region or loading an existing geographic region. Zoning module 110 can obtain information associated with the geographic region from a geographic data source (e.g., geographic knowledge base 140, third-party geographic database 182) and then in 330, provide a visual representation of the geographic region to UI 170.

In 340, zoning module 110 can receive, via UI 170, user-provided parameters with which to partition the geographic region into one or more zones, such as one or more identifiers or attributes that identify or define the zones. Identifiers can identify one or more existing zones, one or more natural or manmade boundaries or features, and the like. Attributes can define a geographic area based on a set of coordinates, a total area, a center and a radius, population or population density, demographics, and the like. Zoning module 110 can obtain, via UI 170, a set of user-selected coordinates, an example of which is shown in FIG. 5 and described in greater detail below. Zoning module 110 can also validate the user-provided parameters, for example, to ensure that the zones generated based on the user-provided parameters would be non-overlapping, i.e., the zones would be discrete.

In 350, zoning module 110 can divide the geographic region into user-customized zones based on the user-provided parameters for the zones. Zoning module 100 can translate the user-provided parameters for the zones into sets of coordinates that each defines a closed shape enclosing a respective zone. Then, in 360, zoning module 110 can provide the user-customized zones, for example, to UI 170 for display, to scheduling engine 120 for scheduling events in the user-customized zones, to geographic knowledge base 140 for storage and future retrieval, etc.

Returning to FIG. 2, in 220, automated event scheduling system 100 can provide time slots and assign the zones partitioned from the geographic region to the time slots. The time slots can be temporally discrete, and each time slot can have a predefined duration. Automated event scheduling system 100 can determine a time frame and divide the time frame into discrete time slots that have a specified time duration and/or periodicity, and can assign one or more of the zones in the geographic region to each of the time slots.

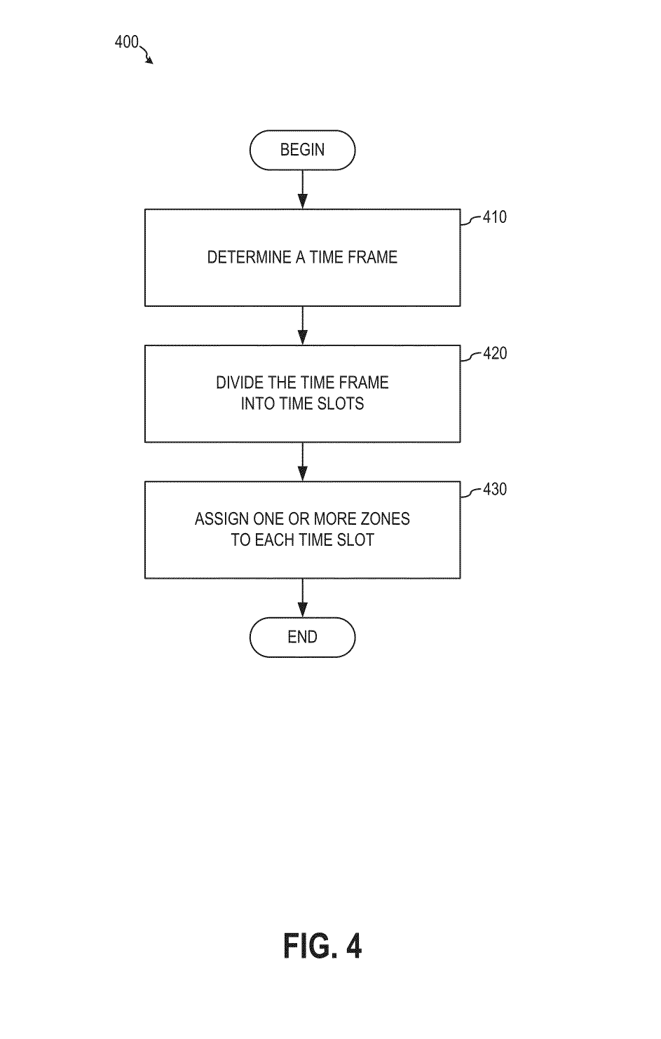

More particularly, automated event scheduling system 100 can invoke scheduling engine 120 to perform processing 400 as shown in FIG. 4. Processing 400 begins in 410, during which automated event scheduling system 100 can use scheduling engine 120 to determine or set a time frame available for events transpiring in the geographic region. Scheduling engine 120 can determine or set a length or duration of the time frame based on, for example, a number and/or type of events being scheduled, a previously saved time frame retrieved from events and data repository 150, user input received via UI 170, and the like. For instance, scheduling engine 120 can set the time frame for open houses in the city of San Francisco to span six weekends, an example of which is shown in FIG. 9B and described in greater detail below.

Next, in 420, scheduling engine 120 can divide the time frame into a number of available time slots. Scheduling engine 120 can determine the number of available time slots based on, for example, a number and/or type of events being scheduled, length or duration of the time frame, amount of time allotted to each time slot, previously saved time slots retrieved from events and data repository 150, user input received via UI 170, and the like. For instance, scheduling engine 120 can determine that there should be thirty-six available time slots, six per weekend over the course of six weekends, for open houses in San Francisco, an example of which is shown in FIG. 9B and described in greater detail below.

In 430, scheduling engine 120 can assign one or more time slots to each zone in the geographic region. In some embodiments, scheduling engine 120 can assign each time slot to at most one zone in the geographic region. In other embodiments, scheduling engine 120 can assign each time slot to any number of zones in the geographic region. Any number of events having venues located in a zone in the geographic region can be scheduled to transpire during a time slot assigned to that zone. In various embodiments, scheduling engine 120 can assign time slots to each of the zones based on a scheduling scheme, such as a static scheduling scheme, a cyclical scheduling scheme, a custom scheduling scheme, etc., or any combination thereof. Using a static scheduling scheme, scheduling engine 120 can statically assign time slots having the same day of the week and the same time of the day to each zone, an example of which is illustrated in Table 1. In the following tables, exemplary time slots A-F can correspond to predefined periods of time. For instance, time slot A can correspond to Saturday late mornings, time slot B can correspond to Saturday early afternoons, time slot C can correspond to Saturday late afternoons, time slot D can correspond to Sunday late mornings, time slot E can correspond to Sunday early afternoons, and time slot F can correspond to Sunday late afternoons.

TABLE 1
An exemplary time slot schedule using a static scheduling scheme

| | Week 1 | Week 2 | Week 3 | Week 4 | Week 5 | Week 6 |
|---|---|---|---|---|---|---|
| Time slot A | Zone 1 | Zone 1 | Zone 1 | Zone 1 | Zone 1 | Zone 1 |
| Time slot B | Zone 2 | Zone 2 | Zone 2 | Zone 2 | Zone 2 | Zone 2 |
| Time slot C | Zone 3 | Zone 3 | Zone 3 | Zone 3 | Zone 3 | Zone 3 |
| Time slot D | Zone 4 | Zone 4 | Zone 4 | Zone 4 | Zone 4 | Zone 4 |
| Time slot E | Zone 5 | Zone 5 | Zone 5 | Zone 5 | Zone 5 | Zone 5 |
| Time slot F | Zone 6 | Zone 6 | Zone 6 | Zone 6 | Zone 6 | Zone 6 |

Using a cyclical scheduling scheme, scheduling engine 120 can, for example, assign time slots to each zone by cycling through days available each week and/or time slots available for each day. Different types of the cyclical scheduling scheme are possible, such as a full cyclical scheduling scheme, a partial cyclical scheduling scheme, and the like, examples of which are illustrated in Tables 2-4.

TABLE 2
An exemplary time slot schedule using a full cyclical
scheduling scheme

| | Week 1 | Week 2 | Week 3 | Week 4 | Week 5 | Week 6 |
|---|---|---|---|---|---|---|
| Time slot A | Zone 1 | Zone 6 | Zone 5 | Zone 4 | Zone 3 | Zone 2 |
| Time slot B | Zone 2 | Zone 1 | Zone 6 | Zone 5 | Zone 4 | Zone 3 |
| Time slot C | Zone 3 | Zone 2 | Zone 1 | Zone 6 | Zone 5 | Zone 4 |
| Time slot D | Zone 4 | Zone 3 | Zone 2 | Zone 1 | Zone 6 | Zone 5 |
| Time slot E | Zone 5 | Zone 4 | Zone 3 | Zone 2 | Zone 1 | Zone 6 |
| Time slot F | Zone 6 | Zone 5 | Zone 4 | Zone 3 | Zone 2 | Zone 1 |

TABLE 3
An exemplary time slot schedule using a first partial cyclical
scheduling scheme

| | Week 1 | Week 2 | Week 3 | Week 4 | Week 5 | Week 6 |
|---|---|---|---|---|---|---|
| Time slot A | Zone 1 | Zone 3 | Zone 2 | Zone 1 | Zone 3 | Zone 2 |
| Time slot B | Zone 2 | Zone 1 | Zone 3 | Zone 2 | Zone 1 | Zone 3 |
| Time slot C | Zone 3 | Zone 2 | Zone 1 | Zone 3 | Zone 2 | Zone 1 |
| Time slot D | Zone 4 | Zone 6 | Zone 5 | Zone 4 | Zone 6 | Zone 5 |
| Time slot E | Zone 5 | Zone 4 | Zone 6 | Zone 5 | Zone 4 | Zone 6 |
| Time slot F | Zone 6 | Zone 5 | Zone 4 | Zone 6 | Zone 5 | Zone 4 |

TABLE 4
An exemplary time slot schedule using a second partial cyclical
scheduling scheme

| | Week 1 | Week 2 | Week 3 | Week 4 | Week 5 | Week 6 |
|---|---|---|---|---|---|---|
| Time slot A | Zone 1 | Zone 6 | Zone 2 | Zone 4 | Zone 3 | Zone 5 |
| Time slot B | Zone 2 | Zone 4 | Zone 3 | Zone 5 | Zone 1 | Zone 6 |
| Time slot C | Zone 3 | Zone 5 | Zone 1 | Zone 6 | Zone 2 | Zone 4 |
| Time slot D | Zone 4 | Zone 3 | Zone 5 | Zone 1 | Zone 6 | Zone 2 |
| Time slot E | Zone 5 | Zone 1 | Zone 6 | Zone 2 | Zone 4 | Zone 3 |
| Time slot F | Zone 6 | Zone 2 | Zone 4 | Zone 3 | Zone 5 | Zone 1 |

Returning to FIG. 2, in 230, scheduling engine 120 can schedule events for one or more time slots assigned to a particular zone in which the events are to take place. For events with venues located in any one of geographic elements in a particular zone within the geographic region, scheduling engine 120 can schedule those events to transpire during the time slots assigned to that particular zone. Furthermore, scheduling engine 120 can store data associated with the zones as well as the time slots and events associated therewith in system storage provided by automated event scheduling system 100, such as geographic knowledge base 140 and/or events and data repository 150. Scheduling engine 120 can receive or retrieve data from zoning module 110 and the system storage, as well as various other data sources such as users via UI 170, third-party databases 180, and/or data sources 190. Next, in 240, automated event scheduling system 100 can determine whether or not to assign additional time slots to the zones partitioned from the geographic region and/or schedule additional events for the additional time slots. If yes, then processing 200 returns to 220; if not, then in 250, automated event scheduling system 100 can provide the events and the events' scheduled time slots and/or associated zones, and processing 200 ends.

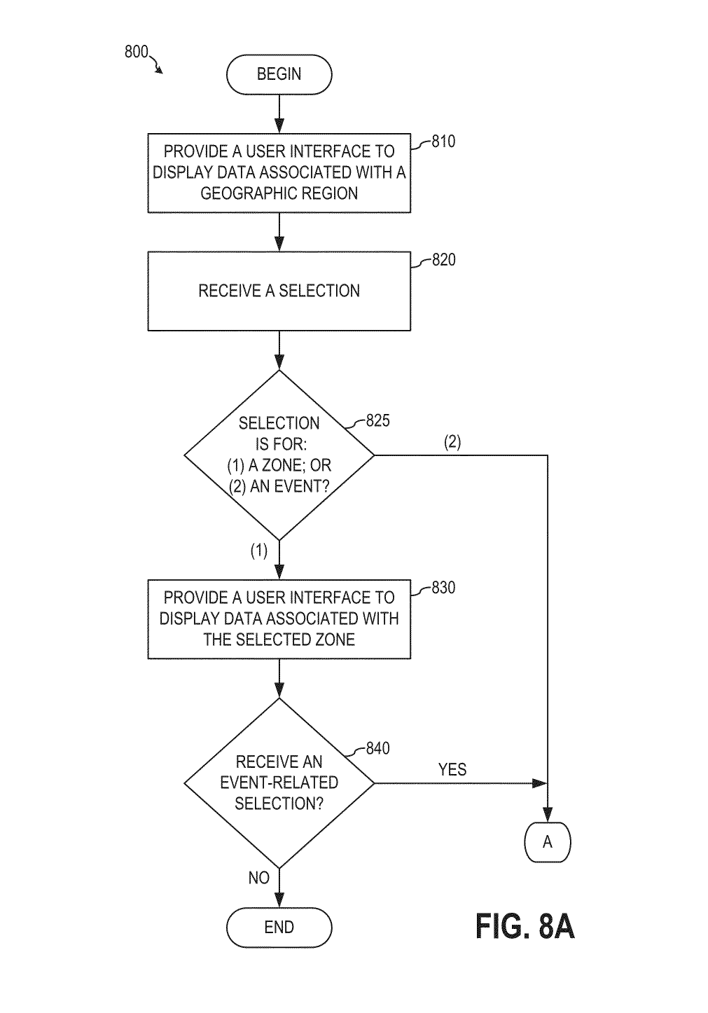

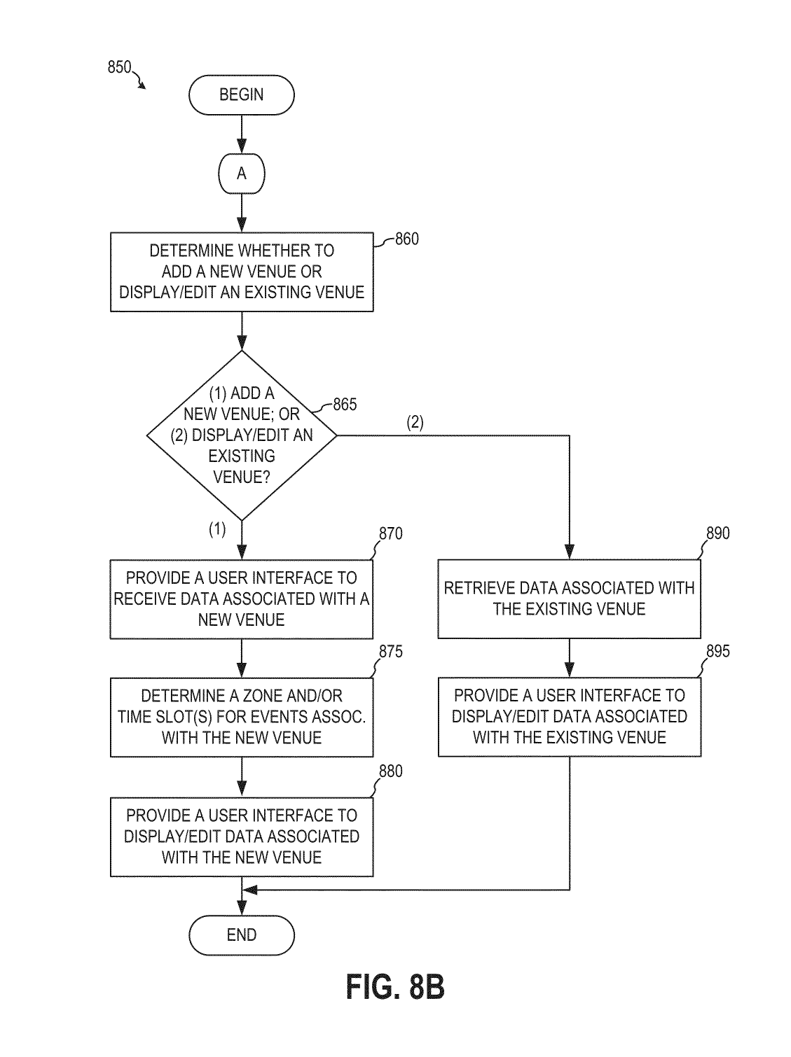

FIG. 8A illustrates a flowchart of processing 800 that can be performed by automated event scheduling system 100 to allow a user to view, select, create, and/or modify data associated with a geographic region, in accordance with embodiments of the present teachings. Processing 800 begins in 810, during which automated event scheduling system 100 can use system interface 130 to provide UI 170 with display data associated with a geographic region.

When performing processing 800, automated event scheduling system 100 can provide a UI, such as, for example, GUI 900 as shown in FIG. 9A. For example and as shown in FIG. 9A, automated event scheduling system 100 can use system interface 130 to provide GUI 900 to users, for accessing and viewing open house events taking place at properties in neighborhoods located in one or more zones partitioned from a geographic region. GUI 900 can include a geographic region descriptor 902, event type legends 904, time slot legends 906, a geographic region display 910, and an agenda listing 940. Geographic region descriptor 902 can include a name or an identifier that describes the geographic region, such as, for example, a state or province name, a county name, a city name, a ZIP code, a name of a university or corporate campus or other institutional properties, a set of names or identifiers of streets that bound the geographic region, a set of geospatial coordinates, a cellular sector identifier, a telephone area code, an identifier for a wireless communication service area, and the like, or a combination thereof. Event type legends 904 can provide legends for various types of events and/venues associated the events. For example, in the open house example as shown in FIG. 9A, event type legends 904 can include legends that indicate whether an event involves a property that is for sale, for rent, or not participating at the moment. Time slot legends 906 can provide legends for the different time slots assigned to the geographic region, such as, for example, different colors or patterns which can be overlaid on geographic region display 910 to indicate the time slots assigned to the zones in the geographic region.

Geographic region display 910 can include a graphical representation of the geographic region, and can display a zone 920 in the geographic region. Geographic region display 910 can display zone 920 in its entirety or a selected portion 925 of zone 920, along with events 930 having venues located within selected portion 925 and are scheduled to transpire in one or more time slots assigned to zone 920. Geographic region display 910 can also display selected events 930a-b, even if selected events 930a-b have venues located outside of selected portion 925 of zone 920. GUI 900 can include more detailed information associated with selected events 930a-b, for example, in agenda listing 940. Agenda listing 940 can be organized based on available time slots, such as, for example, time slots 942a-f. In the example as shown in FIG. 9A, automated event scheduling system 100 has assigned time slot 942a to zone 920, and thus agenda listing 940 indicates that selected events 930a-b are scheduled to transpire during time slot 942a.

Returning to FIG. 8A, in 820, automated event scheduling system 100 can receive a selection from a user, for example, via UI 170. The selection can be for a zone (or a portion therein) partitioned from the geographic region or for an event that has a venue located in the geographic region. In 825, automated event scheduling system 100 can determine whether the selection is for a zone or an event. If automated event scheduling system 100 determines in 825 that the selection is for an event, then automated event scheduling system 100 can proceed to processing 850, which is shown in FIG. 8B and described in greater detail below.

Alternatively, if automated event scheduling system 100 determines in 825 that the selection is for a zone or a portion within a zone, then automated event scheduling system 100 can proceed to 830 and provide UI 170 with display data associated with the selected zone or the selected portion of the zone. For example, automated event scheduling system 100 can provide display data associated with a zone 920, such as its geographic coverage as shown in FIG. 9A. Automated event scheduling system 100 can also provide display data associated with zone 920 or selected portion 925 of zone 920, such as events 930 having venues located within selected portion 925 and scheduled to transpire in one or more time slots assigned to zone 920, as shown in FIG. 9A and described in greater detail below. Finally, in 840, automated event scheduling system 100 can monitor for user selection and determine whether or not it has received an event-related selection, such as a user selection to create, add, view, modify, or access an event and/or a venue where the event is to take place. If yes, then automated event scheduling system 100 can proceed to processing 850; if not, then processing 800 ends.

FIG. 8B illustrates a flowchart of processing 850 that can be performed by automated event scheduling system 100 to allow a user to view, select, create, and/or modify event schedule and venue data associated with a venue, in accordance with embodiments of the present teachings. Processing 850 begins in 860, during which automated event scheduling system 100 can determine whether to add a new venue or to display and/or edit an existing venue based on, for example, input from a user via UI 170.

For example, when performing processing 850, automated event scheduling system 100 can provide a UI, such as, for example, GUI 950 as shown in FIG. 9B. For example and as shown in FIG. 9A, GUI 950 can include a venue descriptor, such as an address 955 of the venue. GUI 950 can also include a time frame 960 spanning six weekends 961-966 during which events can transpire at the venue. Automated event scheduling system 100 can divide time frame 960 into six discrete three-hour daily time slots 970a-c per weekend of six weekends 961-966, resulting in thirty-six discrete three-hour time slots over the span of six weekends 961-966 in time frame 960.

Automated event scheduling system 100 can then use a scheduling scheme to determine which of the thirty-six time slots are available to events taking place at the venue. As shown for example in FIG. 9B, automated event scheduling system 100 can use a partial cyclical scheduling scheme as shown, for example, in Table 4, to generate available time slots 971-976. For instance, scheduling engine 120 can cycle through days available (e.g., Saturday or Sunday) for six weekends 961-966 in time frame 960 to assign a day, and also through first, second, and third daily time slots 970a-c (e.g., 9 am-12 pm for time slot 970a, 12 pm-3 pm for time slot 970b, and 3 pm-6 pm for time slot 970c) in each of the available days to assign a time slot. Other scheduling schemes are possible and can be applied by one of skill in the art. For example, using a static scheduling scheme as shown in Table 1, scheduling engine 120 can statically assign time slots having the same day and the same time slot available for each day to each of the zones. Thus, under the static scheduling scheme, a first zone can be assigned a first available time slot (e.g., 9 am-12 pm) in the first available day (e.g., Saturday), a second zone can be assigned the second available time slot (e.g., 12 pm-3 pm) in the first available day, a third zone can be assigned the third available time slot (e.g., 3 pm-6 pm) in the first available day, a fourth zone can be assigned the first available time slot (e.g., 9 am-12 pm) in the second available day (e.g., Sunday), and so on.

After determining available time slots 971-976 during which events can transpire at the venue, automated event scheduling system 100 can display available time slots 971-976 to a user, and the user can select one or more time slots (e.g., time slot 971 and time slot 974 as shown in FIG. 9B) to reserve those time slots for the events to transpire at the venue. The number of time slots that can be reserved can be limited based on, for example, a number of credits 980 that the user owns. A credit is a unit of value that can be used to reserve one or more available time slots for one or more events at a venue, and credits can be purchased, earned, and/or collected through other various types of transactions, such as promotional deals, exchange of goods or services, incentives for signing up to use automated event scheduling system 100, and the like. In the example as shown in FIG. 9B, number of credits 980 the user has remaining is three, and thus he can reserve up to three of the four remaining available time slots (e.g., time slot 972, time slot 973, time slot 975, and time slot 976).

Returning to FIG. 8B, in 865, if automated event scheduling system 100 determines that the user wants to add or create a new venue, then processing 850 can proceed to 870, during which automated event scheduling system 100 can use UI 170 to inquire the user for data for creating the new venue, such as an address or geographic location of the venue. Next, in 875, automated event scheduling system 100 can determine and assign a zone to events that will take place in the new venue based on, for example, a geographic location of the new venue. Based on the new venue's assigned zone, automated event scheduling system 100 can schedule the events, which are to take place at the new venue, for one or more time slots assigned to the zone. Then, in 880, automated event scheduling system 100 can use system interface 130 to provide display data to UI 170 to display an event schedule and venue data associated with the new venue or to allow the user to edit data associated with the new venue. For example, automated event scheduling system 100 can use system interface 130 to generate a GUI 950 to provide data associated with open house events for a property located at address 955, such data including, for example, time slots available for the open house events taking place at the property located at address 955 as shown in FIG. 9B.

Alternatively, if in 865 automated event scheduling system 100 determines that the user wants to access an existing venue, then processing 850 can proceed to 890, during which automated event scheduling system 100 can retrieve data associated with the existing venue from, for example, events and data repository 150. Then, in 895, automated event scheduling system 100 can use system interface 130 to provide display data to UI 170 to display an event schedule and venue data associated with the existing venue or to allow the user to edit data associated with the existing venue. Finally, after 880 or 895, processing 850 ends.

FIG. 10 illustrates a computer system 1000 that is consistent with embodiments of the present teachings. In general, embodiments of the present teachings may be implemented in various computer systems, such as a personal computer, a server, a workstation, an embedded system, or a combination thereof. Certain embodiments of automated event scheduling system 100 may be embedded as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. However, for purposes of explanation, system 1000 is shown as a general purpose computer that is well known to those skilled in the art. Examples of the components that may be included in system 1000 will now be described.

As shown, system 1000 may include at least one processor 1002, a keyboard 1017, a pointing device 1018 (e.g., a mouse, a touchpad, and the like), a display 1016, main memory 1010, an input/output controller 1015, and a storage device 1014. Storage device 1014 can comprise, for example, RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. A copy of the computer program embodiment of automated event scheduling system 100 can be stored on, for example, storage device 1014. The computer program embodiment can create, access, and/or modify geographic knowledge base 140 and/or events and data repository 150 on storage device 1014, and can include instructions for creating, accessing, and/or modifying geographic knowledge 140 and/or events and data repository 150 on a remote storage device communicatively coupled to system 1000. System 1000 may also be provided with additional input/output devices, such as a printer (not shown). The various components of system 1000 communicate through a system bus 1012 or similar architecture. In addition, system 1000 may include an operating system (OS) 1020 that resides in memory 1010 during operation, and a copy of the computer program embodiment can be stored in memory 1010 during runtime. One skilled in the art will recognize that system 1000 may include multiple processors 1002. For example, system 1000 may include multiple copies of the same processor. Alternatively, system 1000 may include a heterogeneous mix of various types of processors. For example, system 1000 may use one processor as a primary processor and other processors as co-processors. For another example, system 1000 may include one or more multi-core processors and one or more single core processors. Thus, system 1000 may include any number of execution cores across a set of processors (e.g., processor 1002). As to keyboard 1017, pointing device 1018, and display 1016, these components may be implemented using components that are well known to those skilled in the art. One skilled in the art will also recognize that other components and peripherals may be included in system 1000.

Main memory 1010 serves as a primary storage area of system 1000 and holds data that is actively used by applications, such as automated event scheduling system 100, running on processor 1002. One skilled in the art will recognize that applications are software programs that each contains a set of computer instructions for instructing system 1000 to perform a set of specific tasks, and that the term “applications” may be used interchangeably with application software, application programs, and/or programs in accordance with embodiments of the present teachings. Memory 1010 may be implemented as a random access memory or other forms of memory as described below, which are well known to those skilled in the art.

OS 1020 is an integrated collection of routines and instructions that are responsible for the direct control and management of hardware in system 1000 and system operations. Additionally, OS 1020 provides a foundation upon which to run application software. For example, OS 1020 may perform services, such as resource allocation, scheduling, input/output control, and memory management. OS 1020 may be predominantly software, but may also contain partial or complete hardware implementations and firmware. Well known examples of operating systems that are consistent with the principles of the present teachings include Linux™, Mac OS™ by Apple Computer, Solaris™ by Sun Microsystems, Windows™ (e.g., Windows CE™, Windows NT™, Windows 2000™, Windows XP™, and Windows Vista™) by Microsoft Corporation, Open VMS™, and AIX™ by IBM.

The foregoing description is illustrative, and variations in configuration and implementation may occur to persons skilled in the art. For instance, the various illustrative logics, logical blocks, modules, and circuits described in connection with the embodiments disclosed herein may be implemented or performed with a general purpose processor (e.g., processor 1002), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

If implemented in software, the functions may be stored on or transmitted over a computer-readable medium as one or more instructions or code. Computer-readable media includes both tangible computer storage media and communication media including any medium that facilitates transfer of a computer program from one place to another. A storage media may be any available tangible media that can be accessed by a computer. By way of example, and not limitation, such tangible computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Resources described as singular or integrated can in one embodiment be plural or distributed, and resources described as multiple or distributed can in embodiments be combined. The scope of the present teachings is accordingly intended to be limited only by the following claims.

What is claimed is:

1. A method of providing and scheduling related events in user-customized zones in a geographic region, comprising:
providing a scheduling client to a remote user device for installation on the remote user device;
obtaining, from a geographic data source, a geographic region;
providing a zone request to the remote user device, wherein the zone request specifies the geographic region and activates the scheduling client to cause the remote user device to provide at least one user interface (UI) that displays the geographic region and obtains one or more user-provided parameters associated with one or more zones in the geographic region;
receiving, from the remote user device, the one or more user-provided parameters;
dividing, based on the one or more user-provided parameters, the geographic region into a plurality of zones;
providing a set of zone assignments for a plurality of time slots, wherein the set of zone assignments assigns the plurality of zones to the plurality of time slots; and
transmitting the set of zone assignments to the remote user device,
wherein the set of zone assignments activates the scheduling client to cause the remote user device to display, via the UI, the set of zone assignments and enable a modification of the set of zone assignments.

2. The method of claim 1, further comprising:
translating the one or more user-provided parameters into a plurality of coordinates associated with the geographic region, wherein the one or more user-provided parameters include at least one of a set of points, a set of attributes associated with a geographic area, an identifier associated with a boundary, or an identifier associated with a geographic feature; and
dividing, based on the plurality of coordinates, the geographic region into the plurality of zones.

3. The method of claim 2, wherein dividing the geographic region further comprising:
validating that the plurality of coordinates provide the plurality of zones that are non-overlapping; and
dividing, based on the plurality of coordinates, the geographic region into the plurality of zones that are non-overlapping.

4. The method of claim 1, further comprising:
receiving, from the remote user device, the modification of the set of zone assignments; and
updating the set of zone assignments based on the modification of the set of zone assignments.

5. The method of claim 1, further comprising:
receiving, from the geographic data source, stationary geographic elements in the geographic region, wherein the plurality of zones each contains a plurality of the stationary geographic elements;
receiving, from an events data source, a plurality of related events that are each associated with at least one of the stationary geographic elements in the geographic region; and
scheduling, for each of the plurality of zones, a subset of related events selected from the plurality of related events for the at least one time slot assigned to the zone, wherein each related event in the subset of related events has a venue located in the zone.

6. The method of claim 5, further comprising:
receiving a user-selected portion of the geographic region;
generating an area of interest that includes at least one of the plurality of zones containing the user-selected portion and at least one event of interest having at least one venue located in the area of interest; and
transmitting the area of interest to the remote user device,
wherein the area of interest activates the scheduling client to cause the remote user device to display the at least one event of interest, provide at least one user-selectable link corresponding to the at least one event of interest, and enable, via the at least one user-selectable link, a selection of the at least one event of interest to access at least one event schedule associated with the at least one event.

7. The method of claim 5, wherein receiving the plurality of related events further comprises:
selecting the plurality of related events based on the at least one stationary geographic element associated with each related event of the plurality of related events.

8. The method of claim 5, wherein the stationary geographic elements each includes a discrete partition of the geographic region.

9. The method of claim 1, wherein providing the set of zone assignments further comprises:
assigning the plurality of zones to the plurality of time slots such that each of the plurality of zones is assigned to at most one of the plurality of time slots.

10. The method of claim 1, wherein the plurality of time slots are temporally discrete.

11. The method of claim 1, further comprising:
providing the plurality of time slots based on a number of the plurality of zones.

12. The method of claim 1, wherein providing the set of zone assignments further comprises:
assigning the plurality of zones to the plurality of time slots on a cyclical basis.

13. The method of claim 1, wherein scheduling further comprises:
selecting at least one time slot from the plurality of time slots;
receiving a first time slot selected from the at least one time slot; and
scheduling the event for the first time slot.

14. A system comprising:
a geographic data source;
a server that provides and schedules related events in user-customized zones in a geographic region, wherein the server performs a method comprising:
providing a scheduling client to a remote user device for installation on the remote user device;
obtaining, from the geographic data source, the geographic region;
providing a zone request to the remote user device, wherein the zone request specifies the geographic region and activates the scheduling client to cause the remote user device to provide at least one user interface (UI) that displays the geographic region and obtains one or more user-provided parameters associated with one or more zones in the geographic region;
receiving, from the remote user device, the one or more user-provided parameters;
dividing, based on the one or more user-provided parameters, the geographic region into a plurality of zones;
providing a set of zone assignments for a plurality of time slots, wherein the set of zone assignments assigns the plurality of zones to the plurality of time slots; and
transmitting the set of zone assignments to the remote user device,
wherein the set of zone assignments activates the scheduling client to cause the remote user device to display, via the UI, the set of zone assignments and enable a modification of the set of zone assignments.

15. The system of claim 14, wherein the server further performs the method comprising:
translating the one or more user-provided parameters into a plurality of coordinates associated with the geographic region, wherein the one or more user-provided parameters include at least one of a set of points, a set of attributes associated with a geographic area, an identifier associated with a boundary, or an identifier associated with a geographic feature; and
dividing, based on the plurality of coordinates, the geographic region into the plurality of zones.

16. The system of claim 15, wherein the server further performs the method comprising:
validating that the plurality of coordinates provide the plurality of zones that are non-overlapping; and
dividing, based on the plurality of coordinates, the geographic region into the plurality of zones that are non-overlapping.

17. The system of claim 14, wherein the server further performs the method comprising:
receiving, from the remote user device, the modification of the set of zone assignments; and
updating the set of zone assignments based on the modification of the set of zone assignments.

18. The system of claim 14, wherein the server further performs the method comprising:
assigning the plurality of zones to the plurality of time slots such that each of the plurality of zones is assigned to at most one of the plurality of time slots.

19. The system of claim 14, wherein the plurality of time slots are temporally discrete.

20. A non-transitory computer-readable storage medium containing instructions which, when executed on a location-based event scheduler, perform a method of providing and scheduling related events in user-customized zones in a geographic region, the method comprising:
providing a scheduling client to a remote user device for installation on the remote user device;
obtaining, from a geographic data source, a geographic region;
providing a zone request to the remote user device, wherein the zone request specifies the geographic region and activates the scheduling client to cause the remote user device to provide at least one user interface (UI) that displays the geographic region and obtains one or more user-provided parameters associated with one or more zones in the geographic region;
receiving, from the remote user device, the one or more user-provided parameters;
dividing, based on the one or more user-provided parameters, the geographic region into a plurality of zones;
providing a set of zone assignments for a plurality of time slots, wherein the set of zone assignments assigns the plurality of zones to the plurality of time slots; and
transmitting the set of zone assignments to the remote user device,
wherein the set of zone assignments activates the scheduling client to cause the remote user device to display, via the UI, the set of zone assignments and enable a modification of the set of zone assignments.
